(19) United States
(12) Patent Application Publication
(10) Pub. No.: US 2014/0003532 A1
(43) Pub. Date: Jan. 2, 2014

(54) WAVEFRONT PARALLEL PROCESSING FOR VIDEO CODING

(71) Applicant: QUALCOMM Incorporated, San Diego, CA (US)

(72) Inventors: Muhammed Zeyd COBAN, Carlsbad, CA (US); Wei-Jung CHIEN, San Diego, CA (US); Marta KARCZEWICZ, San Diego, CA (US)

(21) Appl. No.: 13/929,198

(22) Filed: Jun. 27, 2013

Related U.S. Application Data
(60) Provisional application No. 61/666,609, filed on Jun. 29, 2012.

(51) Int. Cl. H04N 7/26

(52) U.S. Cl. CPC H04N 19/00521
USPC 375/240.24

(57) ABSTRACT

The techniques of this disclosure allow for wavefront parallel processing of video data with limited synchronization points. In one example, a method of decoding video data comprises synchronizing decoding of a first plurality of video block rows at a beginning of each video block row in the first plurality of video block rows, decoding the first plurality of video block rows in parallel, wherein decoding does not include any synchronization between any subsequent video block in the first plurality of video block rows, and synchronizing decoding of a second plurality of video block rows at a beginning of each video block row in the second plurality of video block rows.

This application claims the benefit of:

U.S. Provisional Application No. 61/666,609, filed Jun. 29, 2012, the entire content of which is incorporated by reference herein.

### TECHNICAL FIELD

This disclosure relates to video coding, and more particularly to techniques for parallel processing in video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as CTBs, CUs, and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for coding video data. More specifically, this disclosure describes techniques for parallel processing of video data.

In one example of the disclosure, a method of decoding video data comprises synchronizing decoding of a first plurality of video block rows at a beginning of each video block row in the first plurality of video block rows, decoding the first plurality of video block rows in parallel, wherein decoding does not include any synchronization between any subsequent video block in the first plurality of video block rows, and synchronizing decoding of a second plurality of video block rows at a beginning of each video block row in the second plurality of video block rows.

In one example, decoding the plurality of video block rows in parallel comprises parsing syntax elements in each video block row, and reconstructing each video block row. In order to allow for synchronization to only occur at the beginning of each video block row, parsing syntax element in each video block row comprises determining a value for each syntax element for a particular video block row without using a syntax element from another video block row. In this way, a line buffer may be eliminated for a lower row in the plurality of video block rows, and multiple video block rows may be processed in parallel without additional synchronization points within the rows.

In another example of the disclosure, a method of encoding video data comprises synchronizing encoding of a first plurality of video block rows at a beginning of each video block row in the first plurality of video block rows, encoding the first plurality of video block rows in parallel, wherein decoding does not include any synchronization between any subsequent video block in the first plurality of video block row, and synchronizing encoding of a second plurality of video block rows at a beginning of each video block row in the second plurality of video block rows.

The techniques of this disclosure will also be described in terms of devices, apparatuses, and computer-readable storage medium that may implement the methods and techniques described herein.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2A is conceptual diagram illustrating an example of synchronization points for wavefront parallel processing.

FIG. 2B is conceptual diagram illustrating another example of synchronization points for wavefront parallel processing.

FIG. 3 is a conceptual diagram illustrating example synchronization points for parallel processing of video block rows according to the techniques of this disclosure.

FIG. 4 is a block diagram illustrating an example video encoder that may implement the techniques described in this disclosure.

FIG. 5 is a block diagram illustrating an example video decoder that may implement the techniques described in this disclosure.

FIG. 6 is a flowchart illustrating an example video encoding method according to the techniques of this disclosure.

FIG. 7 is a flowchart illustrating an example video decoding method according to the techniques of this disclosure.

### DETAILED DESCRIPTION

Wavefront parallel processing is a video coding technique whereby two or more rows of video blocks are coded in parallel. Current techniques for wavefront parallel processing requires synchronization between the two more video block rows at each video block. This is necessary, because the process of parsing syntax elements in each video block row may have a different complexity and may take a different amount of time. Since many syntax elements may require decoded information of other syntax elements (e.g., in a different row) for correct parsing, synchronization may need to be maintained to ensure that such information is available for the parsing process. In particular, a video decoder may use synchronization points to ensure that decoded information of syntax elements from a video block row above the currently coded video block row are available for decoding syntax elements in the current row.

However, the requirement for frequent, per-block synchronization points adds complexity to video coder designs, and may limit the speed at which video data may be coded. In view of this drawback, this disclosure presents techniques for the parallel processing of video block rows, whereby synchronization can be limited to the beginning of a video block row. Further, per-block synchronization points in the row may be eliminated. This may be accomplished by eliminating inter-row dependencies in the parsing of syntax elements.

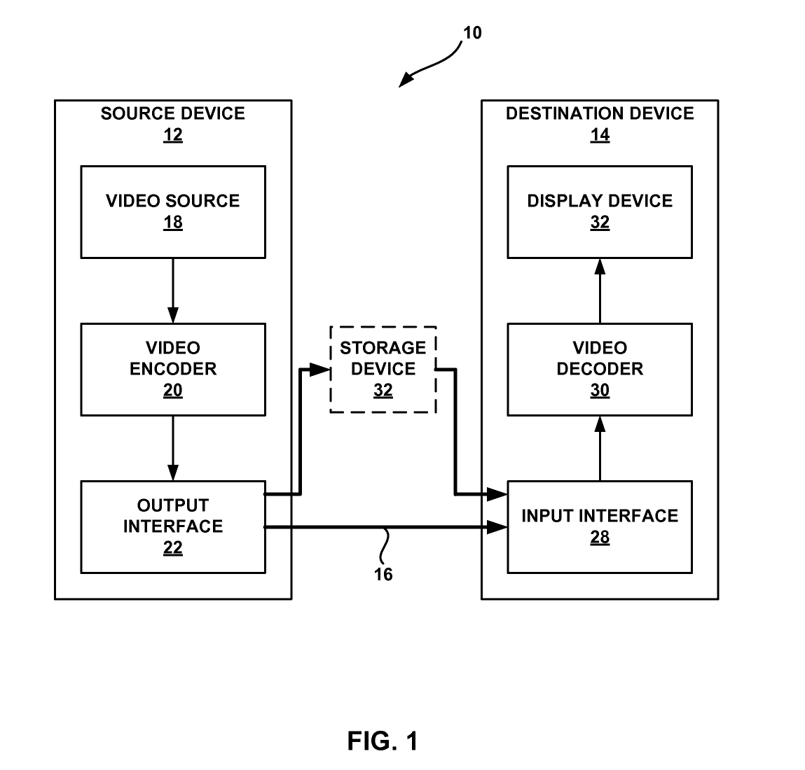

FIG. 1 is a block diagram illustrating an example video encoding and decoding system 10 that may utilize the techniques for parallel video processing described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 32. Similarly, encoded data may be accessed from storage device 32 by input interface. Storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 32 may correspond to a file server or another intermediate storage device that may hold the encoded video generated by source device 12. Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 32 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 32 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 32, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development developed by the Joint Collaboration Team on Video Coding (JCT-VC) of ITU-T Video Coding Experts Group (VCEG) and ISO/IEC Motion Picture Experts Group (MPEG). An example working draft of HEVC (HEVC WD7) is described in Bross, et al., “High efficiency video coding (HEVC) text specification draft 7, and, as of Jun. 26, 2013, is available from http://phenix.int-evry.fr/jct/doc_end_user/documents/9_Geneva/wg11/JCTVC-11003-v5.zip. HEVC WD7 is incorporated by reference herein. Video encoder 20 and video decoder 30 may conform to the HEVC Test Model (HM).

Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

In accordance with the techniques of this disclosure, which will be described in more detail below. Video decoder 30 may be configured to synchronize decoding of a first plurality of video block rows at a beginning of each video block row in the first plurality of video block rows, decode the first plurality of video block rows in parallel, wherein decoding does not include any synchronization between any subsequent video block in the first plurality of video block rows, and synchronize decoding of a second plurality of video block rows at a beginning of each video block row in the second plurality of video block rows.

In one example, vide decoder 30 may be configured to decode the plurality of video block rows in parallel by parsing syntax elements in each video block row, and reconstructing each video block row. In order to allow for synchronization to only occur at the beginning of each video block row, video decoder 30 may be configured to parse syntax element in each video block row by determining a value for each syntax element for a particular video block row without using a syntax element from another video block row. In this way, a line buffer may be eliminated for a lower row in the plurality of video block rows, and multiple video block rows may be processed in parallel without additional synchronization points within the rows.

In another example of the disclosure, video encoder 20 may be configured t synchronize encoding of a first plurality of video block rows at a beginning of each video block row in the first plurality of video block rows, encode the first plurality of video block rows in parallel, wherein decoding does not include any synchronization between any subsequent video block in the first plurality of video block row, and synchronize encoding of a second plurality of video block rows at a beginning of each video block row in the second plurality of video block rows.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of coding tree blocks (CTBs) or largest coding units (LCUs) that include both luma and chroma samples. In many examples, a CTB is an N×N block of samples (e.g., luma or chroma samples). A CTB has a similar purpose as a macroblock of the H.264 standard. A slice includes a number of consecutive CTBs in coding order. A video frame or picture may be partitioned into one or more slices. Each CTB may be split into coding units (CUs) according to a quadtree. For example, a CTB, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a CTB may be split, and may also define a minimum size of the coding nodes.

A CU includes a coding node and prediction units (PUs) and transform units (TUs) associated with the coding node. A size of the CU generally corresponds to a size of the coding node and must typically be square in shape. The size of the CU may range from 8×8 pixels up to the size of the CTB with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more transform units (TUs). Following prediction, video encoder 20 may calculate residual values from the video block identified by the coding node in accordance with the PU. The coding node is then updated to reference the residual values rather than the original video block. The residual values comprise pixel difference values that may be transformed into transform coefficients, quantized, and scanned using the transforms and other transform information specified in the TUs to produce serialized transform coefficients for entropy coding. The coding node may once again be updated to refer to these serialized transform coefficients. This disclosure typically uses the term “video block” to refer to one or more of a CTB, LCU or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data to which the transforms specified by TUs of the CU are applied. The residual data may correspond to pixel differences between pixels of the unencoded picture and prediction values corresponding to the CUs. Video encoder 20 may form the residual data for the CU, and then transform the residual data to produce transform coefficients.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In the current working draft of the HEVC specification, CU split and CU skip flags define certain coding characteristics for a CU. The CU skip flag (e.g., skip flag) specifies whether or not inter-prediction is skipped for the CU. The CU split flag (e.g., IntraSplitFlag) indicates whether an intra-predicted CU is not split (e.g., remains a 2N×2N CU) or is split into smaller CUs (e.g., 4 N×N CUs).

Wavefront parallel processing has been proposed for HEVC. Wavefront parallel processing is a technique whereby two or more CTB rows of video data are encoded and/or decoded at approximately the same time (i.e., in parallel). However, due to inter-dependencies in intra-prediction, inter-prediction, and certain syntax element parsing, parallel decoding of CTB rows is synchronized. That is, video blocks in a current CTB row may use coded information from video blocks in a CTB row above the current CTB row. When processing two CTB rows in parallel, a video decoder must synchronize processing between CTBs in the two rows to ensure that data required by a lower CTB row has already been coded in the upper CTB row.

In this regard, wavefront parallel processing process can be considered to be split into two main parts. The first part is the bitstream parsing process, and the second part is the reconstruction process. The reconstruction part requires synchronization between CTB rows at every CTB. Because a CU in a currently coded CTB row may depend on decoded information in a CU above that CU (i.e., a CU in a CTB row above the current CU), at least one CU in the upper CTB row must be reconstructed before decoding of the lower CTB row can begin.

Typically, reconstruction complexity is balanced between the CTBs. That is, each CTB row typically takes approximately the same amount of time to code pixel information. However, the parser part of wavefront parallel processing may be unbalanced. That is, the time it takes to parse one CTB row may differ substantially from another CTB. Like reconstruction, parsing syntax elements in one row may require the information from already parsed syntax element in the row above the current TOW.

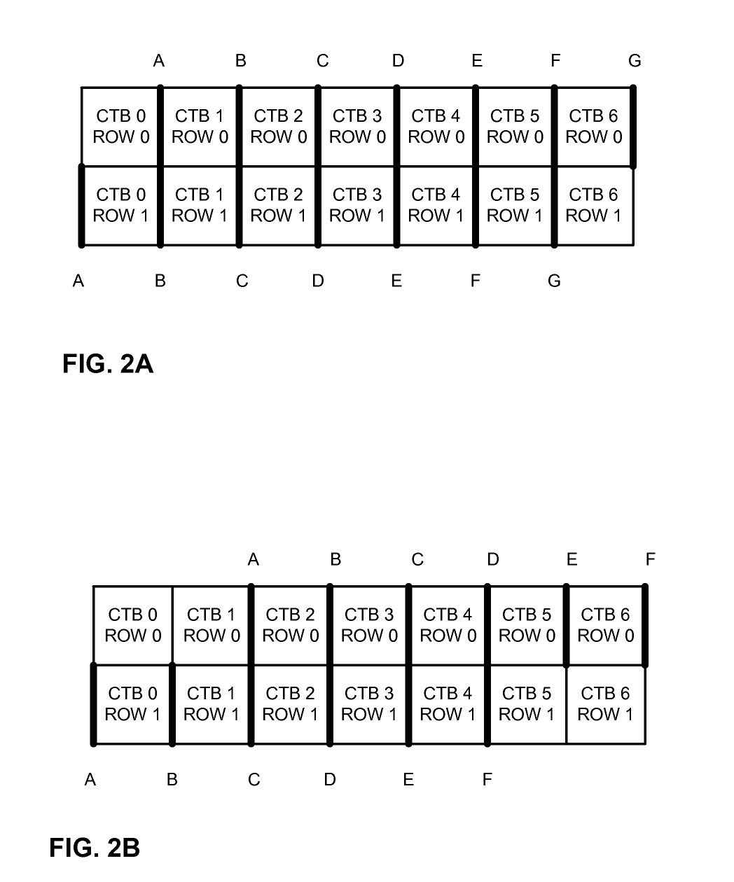

FIGS. 2A and 2B depict conceptual diagrams showing examples of CTB synchronization in wavefront parallel processing. It should be noted that the examples of FIG. 2A and FIG. 2B are presented for illustrative purposes. In other examples, more than two CTB row may be processed in parallel. In addition, a video frame may comprise more or fewer CTBs in a CTB row than the 7 CTBs that are depicted in FIG. 2A and FIG. 2B.

FIG. 2A shows an example of wavefront parallel processing with synchronization points delayed by one CTB. In the example of FIG. 2A, two CTB rows are processed (e.g., decoded) in parallel. Decoding of CTB 0 in CTB row 1, at synchronization point A, does not begin until decoding of CTB row 0 also reaches synchronization point A.

In the example of FIG. 2A, synchronization point A occurs after decoding of CTB 0 in CTB row 0 has been completed. This delay is necessary to allow for the decoding of syntax elements and/or pixel information in CTB 0 in row 1 that rely on decoded syntax elements and/or pixel information in a CTB directly above, or above and to the left of the CTB. That is, video decoder 30 may require certain syntax elements in CTB 0 row 0 to have already been decoded, in order to properly decode syntax elements in CTB 0 row 1. Synchronization points B-G show other points at which coding of row 0 must be finished, before coding of row 1 may begin at the corresponding point. As can be seen, synchronization is required at each CTB. In this context, synchronization does not necessarily require the decoding at, e.g., point A in both rows occur simultaneously. Rather, synchronization merely requires that the decoding of the upper row reaches the synchronization point before decoding in the lower row may begin at the corresponding synchronization point.

FIG. 2B is conceptual diagram illustrating another example of synchronization points for wavefront parallel processing. In this example, decoding of pixel information and/or syntax elements in a lower CTB row (e.g., CTB row 1) may also depend on decoded pixel information and/or syntax elements in a CU located to the above and right of the currently decoded CU. As such, two CTBs in row 0 (i.e., CTB 0 and CTB 1) must be decoded before decoding can begin in CTB row 1. As shown in FIG. 2B, video decoder 30 may begin decoding CTB 0 in CTB row 1 when the decoding of CTB 1 in CTB row 0 has been completed.

Synchronizing the parallel processing of CTB rows at every CTB introduces complexity into a video decoder and/or video encoder. As such, it would be beneficial if synchronization between CTB rows be substantially removed or relaxed so that parsing may occur at different speeds for each CTB row. In view of this drawback, this disclosure proposes to limit per-CTB synchronization by eliminating inter-CTB row dependencies in parsing syntax elements in each CTB row. Such limits on inter-CTB row dependencies may provide beneficial reductions in complexity, without causing any drastic losses in coding efficiency.

As discussed above, syntax elements are typically encoded by entropy encoder in video encoder 20. For example, video encoder 20 may encode syntax elements using CABAC. As such, syntax elements for entire CTBs may be signaled by a single bin or by many bins. It is desirable to have load balancing for the parsing operation between the CTBs. If the synchronization of the parsing module is relaxed to be performed at the beginning of every CTB row, instead of at every CTB, load balancing for parsing of the wavefront substreams (i.e., parsing of each CTB row) can be achieved. Therefore, in order to eliminate the need for per-CTB synchronization, this disclosure proposes that all syntax elements be decodable with out the use of any syntax element information from a CTB row above the currently coded CTB. As such, the need for a line buffer for syntax element parsing is also eliminated. A line buffer is a memory used to store decoded syntax information for video blocks in a row above the currently decoded video block.

A number of syntax elements defined by HEVC may rely on the value of the same syntax element for a video block above the current video block for correct parsing. The techniques of this disclosure propose to eliminate such dependencies to allow wavefront parallel processing to be performed by only synchronizing at the beginning of each CTB row. For illustrative purposes, the techniques of this disclosure will be described with reference to context derivation for the CU split flat and the CU skip flag. However, similar techniques may be applied to the decoding of any syntax element.

As stated above, limiting synchronization of CTB rows to the beginning of the CTB row can be achieved if the correct parsing of a syntax element does not rely on decoded information from the row above. As such, if the dependency of deriving the CU split flag and CU skip flag contexts on the CTB row above are removed, this goal can be achieved.

In earlier proposals for HEVC, techniques for removing the line buffer requirements for the CU skip flag were proposed. A line buffer is used to store information related to a row of coding units above a currently coded row. Thus, removal of line buffer requirements for the CU skip flag also entails the removal of any dependency on CU skip flag information of a CTB row above a currently coded CTB. This disclosure proposes techniques to remove the CU split flag's context dependency on the CU split flag information in the CTB row above the currently coded CU.

In the current working draft of the HEVC specification, the CU split flag context is derived as follows:

uiCtx=splitFlagLeftCU+splitFlagAboveCU; (1)

where splitFlagLeftCU is the split flag value of the CU to the left of the current CU whose CU split flag value is being coded, and splitFlagAboveCU is the split value of the CU above the current CU. The variable uiCtx is the context determined for the currently coded CU split flag. In this case, three contexts (contexts 0, 1, and 2) are used to code the CU split flag, as both splitFlagLeftCU and splitFlagAboveCU may have a value of 0 or 1. If both splitFlagLeftCU and splitFlagAboveCU have a value of 0, then uiCtx is 0. If one of splitFlagLeftCU and splitFlagAboveCU has a value of 1 and the other has a value of 0, then uiCtx is 1. If both splitFlagLeftCU and splitFlagAboveCU have a value of 1, then uiCtx is 2.

This disclosure describes techniques that modify the determination of the CU split flag context as follows, thus removing the dependency on any CU split flag information from the CTB row above the currently coded CU:

uiCtx=splitFlagLeftCU+((uiDepth>>1)<<1); (2)

where uiDepth is the depth of the current CU whose split flag value is being coded. The symbol >> denotes a bit-wise right shift while the symbol << denotes a bit-wise left shift. The depth of the current CU (i.e., the value of uiDepth) may have four values: 0, 1, 2, and 3. The left and right shift operations shown in Equation (2) map the depth values 0, 1, 2, and 3 to the values 0, 0, 2, 2, respectively. As the value of splitFlagLeftCU may be either 0 or 1, the possible values of uiCtx are 0, 1, 2, and 3. Thus, the technique of Equation 2 results in four possible contexts needed to code the CU split flag, while also removing any dependency on CU split flag information from the CTB row above the currently coded CU. As such, synchronization of parsing during wavefront parallel processing is not restricted at every CTB. As discussed above, the basic techniques of removing inter-row dependencies for parsing the CU split flag may be extended to other syntax elements.

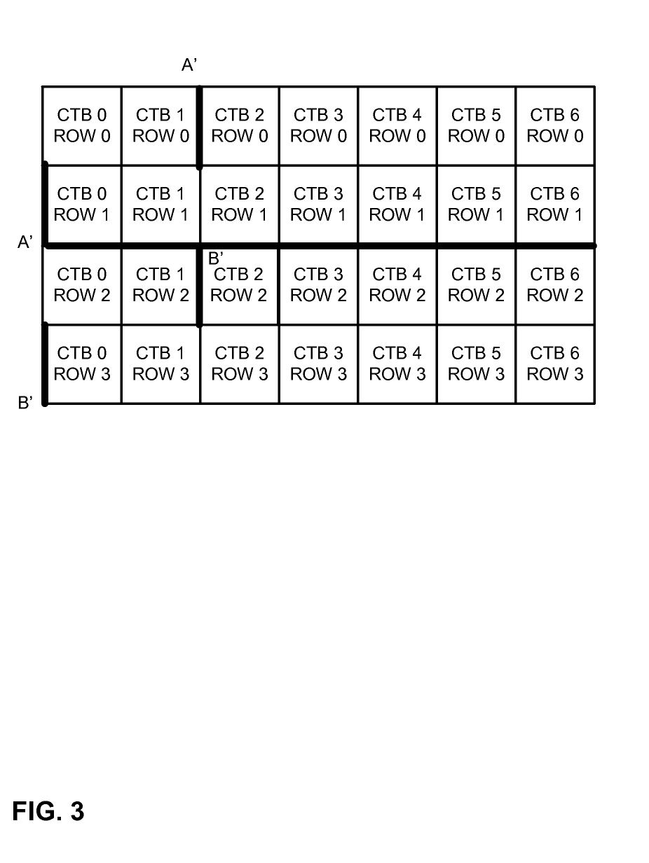

FIG. 3 is a conceptual diagram illustrating example synchronization points for parallel processing of video block rows according to the techniques of this disclosure. In the example of FIG. 3, video encoder 20 and video decoder 30 are configured to parse all syntax elements without using any information from a CTB row above the currently coded CTB row. As such, the parsing part of wavefront parallel processing may proceed from a single synchronization point at the beginning of the CTB row, as any differences in parsing complexity and parsing time between the rows, has no bearing on another row.

As shown in FIG. 3, coding of CTB row 0 may begin before the coding of CTB row 1, as predictive coding techniques (e.g., inter-prediction or intra-prediction) used during the reconstruction process may still rely on pixel information in the row above. As shown in FIG. 3, processing of CTB row 1 may begin as soon as reconstruction of CTB 1 in CTB row 0 is complete. However, unlike the example of FIG. 2A and FIG. 2B, no further synchronization points are used for processing CTB rows 0 and 1. As such, a first plurality of CTB rows may be processed in parallel, using the two CTB delay, with only one synchronization point, i.e., synchronization point A′. A second plurality of CTB rows (i.e., CTB rows 2 and 3) may be coded in parallel by video encoder 20 or video decoder 30 using a single synchronization point B′ after the first plurality of CTB rows are processed.

In the example of FIG. 3, the first and second groups of CTB rows includes two CTB rows. However, more than two CTB rows may be processed in parallel using the techniques of this disclosure.

The techniques described above for removing inter-row dependencies when parsing syntax elements described above can be used with or without wavefront parallel processing. As another example, the removal of inter-row dependencies for deriving the contexts for CU split and skip flags may be used only when wavefront parallel processing is enabled. That is, if wavefront parallel processing is not enabled, the contexts for the CU split flag and CU skip flag may be derived using information from a row above the currently coded CTB.

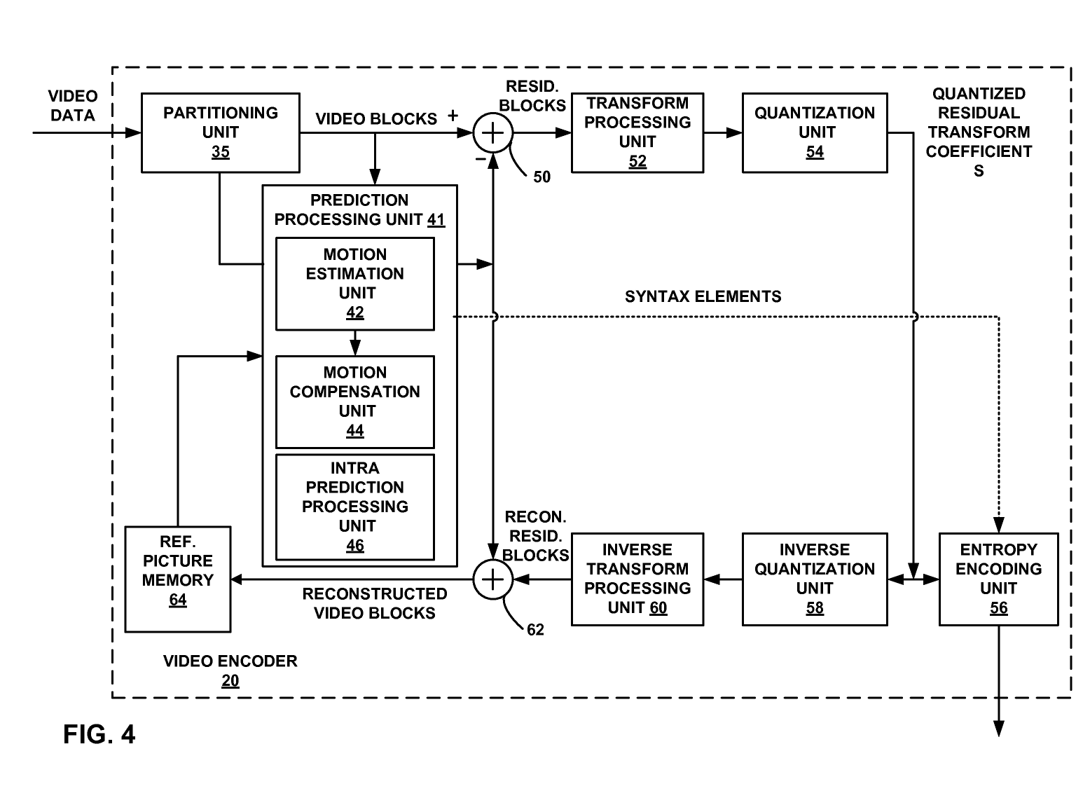

FIG. 4 is a block diagram illustrating an example video encoder 20 that may implement the techniques described in this disclosure. In particular, video encoder 20 may be configured to perform wavefront parallel processing of video data according to techniques of this disclosure. In particular, video encoder 20 may be configure to perform wavefront parallel processing using a synchronization point at the beginning of a CTB row by eliminating inter-row dependencies when coding syntax elements.

Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 4, video encoder 20 includes a partitioning unit 35, prediction processing unit 41, reference picture memory 64, summer 50, transform processing unit 52, quantization unit 54, and entropy encoding unit 56. Prediction processing unit 41 includes motion estimation unit 42, motion compensation unit 44, and intra prediction processing unit 46. For video block reconstruction, video encoder 20 also includes inverse quantization unit 58, inverse transform processing unit 60, and summer 62. A deblocking filter (not shown in FIG. 4) may also be included to filter block boundaries to remove blockiness artifacts from reconstructed video. If desired, the deblocking filter would typically filter the output of summer 62. Additional loop filters (in loop or post loop) may also be used in addition to the deblocking filter.

As shown in FIG. 4, video encoder 20 receives video data, and partitioning unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction processing unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

Intra prediction processing unit 46 may intra-predict a current block, as an alternative to the inter-prediction performed by motion estimation unit 42 and motion compensation unit 44, as described above. In particular, intra prediction processing unit 46 may determine an intra-prediction mode to use to encode a current block. In some examples, intra prediction processing unit 46 may encode a current block using various intra-prediction modes, e.g., during separate encoding passes, and intra prediction processing unit 46 (or mode select unit 40, in some examples) may select an appropriate intra-prediction mode to use from the tested modes. For example, intra prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra prediction processing unit 46 may calculate ratios from the distortions and rates for the various encoded blocks to determine which intra-prediction mode exhibits the best rate-distortion value for the block.

In any case, after selecting an intra-prediction mode for a block, intra prediction processing unit 46 may provide information indicative of the selected intra-prediction mode for the block to entropy coding unit 56. Entropy coding unit 56 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 41 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in reference picture memory 64. The reference block may be used by motion estimation unit 42 and motion compensation unit 44 as a reference block to inter-predict a block in a subsequent video frame or picture.

In accordance with the techniques of this disclosure, video encoder 20 may be configured to determine a context for coding a coding unit split flag for a current coding unit based on a value of a left coding unit split flag associated with a left coding unit positioned to the left of the current coding unit and based on a depth of the current coding unit, thereby removing the need for a line buffer, and entropy code the coding unit split flag using the determined context. In one example, entropy coding is performed using context adaptive arithmetic coding.

In another example of the disclosure, video encoder 20 may be configured determine the context for the current coding unit split flag utilizes the following equation: uiCtx=splitFlagLeftCU+((uiDepth>>1)<<1), wherein uiCtx is the determined context, splitFlagLeftCU is the value of the left coding unit split flag, uiDepth is the depth of the current coding unit, the symbol >> denotes a right shift operation, and the symbol << denotes a left shift operation. This equation produces four possible context values.

Video encoder 20 may be further configured to determine a value for the coding unit split flag, encode the current coding unit according the value of the coding unit split flag, entropy encode the encoded current coding unit, and signal the entropy encoded current coding unit and the entropy encoded coding unit split flag in an encoded video bitstream.

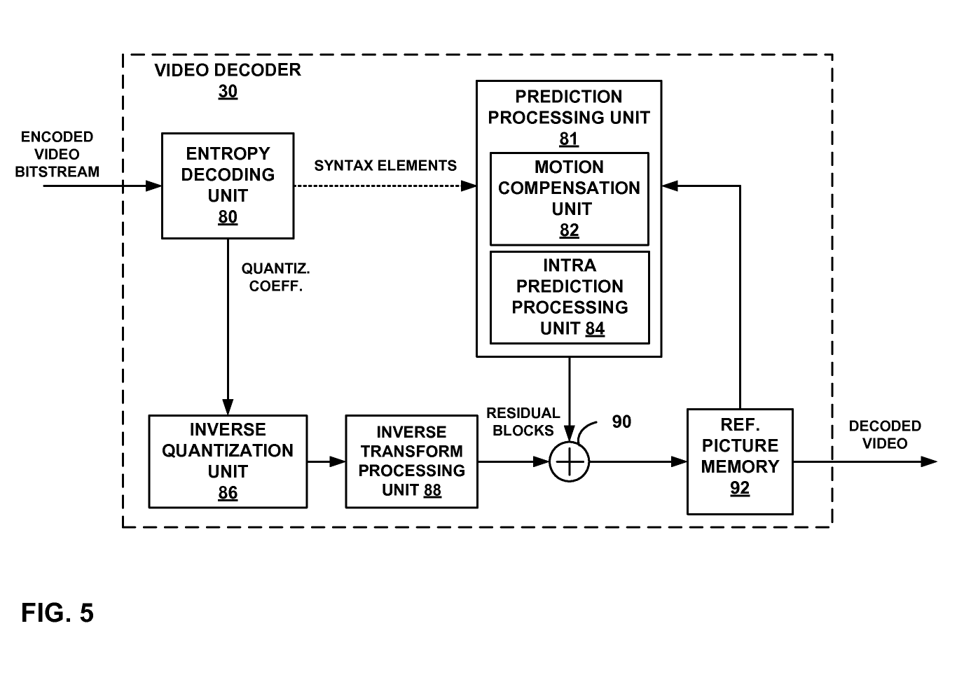

FIG. 5 is a block diagram illustrating an example video decoder 30 that may implement the techniques described in this disclosure. In particular, video encoder 20 may be configured to perform wavefront parallel processing of video data according to techniques of this disclosure. In particular, video encoder 20 may be configure to perform wavefront parallel processing using a synchronization point at the beginning of a CTB row by eliminating inter-row dependencies when parsing syntax elements.

In the example of FIG. 5, video decoder 30 includes an entropy decoding unit 80, prediction processing unit 81, inverse quantization unit 86, inverse transformation unit 88, summer 90, and reference picture memory 92. Prediction processing unit 81 includes motion compensation unit 82 and intra prediction processing unit 84. Video decoder 30 may, in some examples, perform a decoding pass generally reciprocal to the encoding pass described with respect to video encoder 20 from FIG. 4.

During the decoding process, video decoder 30 receives an encoded video bitstream that represents video blocks of an encoded video slice and associated syntax elements from video encoder 20. Entropy decoding unit 80 of video decoder 30 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra prediction processing unit 84 of prediction processing unit 81 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in reference picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform processing unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference picture memory 92 also stores decoded video for later presentation on a display device, such as display device 32 of FIG. 1.

In accordance with the techniques of this disclosure, video decoder 30 may be configured to determine a context for coding a coding unit split flag for a current coding unit based on a value of a left coding unit split flag associated with a left coding unit positioned to the left of the current coding unit and based on a depth of the current coding unit, thereby removing the need for a line buffer, and entropy code the coding unit split flag using the determined context. In one example, entropy coding is performed using context adaptive arithmetic coding.

In another example of the disclosure, video decoder 30 may be configured determine the context for the current coding unit split flag utilizes the following equation: uiCtx=splitFlagLeftCU+((uiDepth>>1)<<1), wherein uiCtx is the determined context, splitFlagLeftCU is the value of the left coding unit split flag, uiDepth is the depth of the current coding unit, the symbol >> denotes a right shift operation, and the symbol << denotes a left shift operation. This equation produces four possible context values.

Video decoder 30 may be further configured to receive an entropy encoded current coding unit and the entropy coded coding unit split flag in an encoded video bitstream, entropy decode the entropy encoded current coding unit, and decode the entropy decoded current coding unit according to the value of the coding unit split flag.

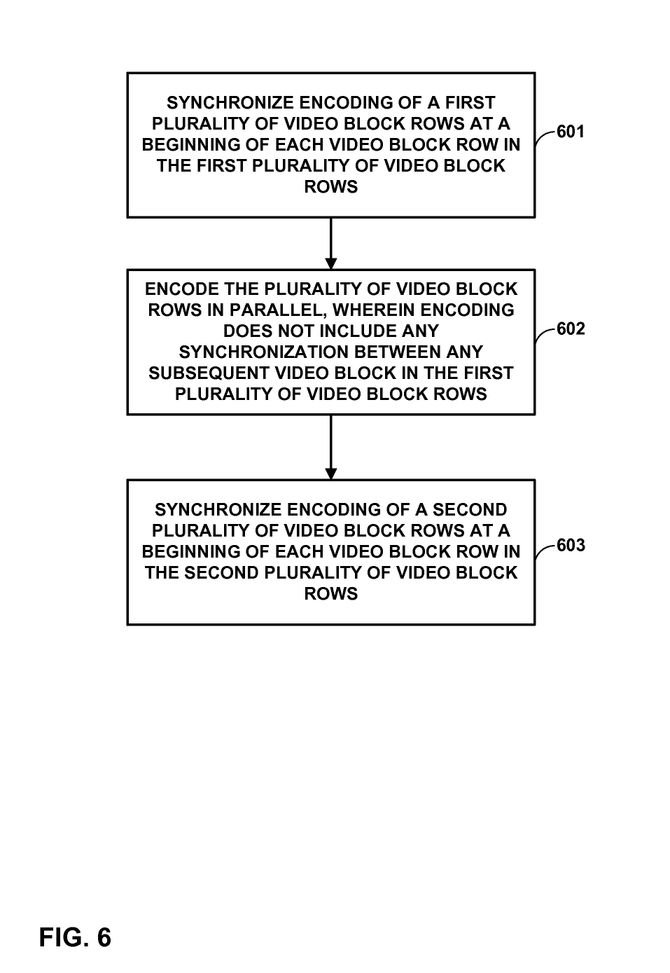

FIG. 6 is a flowchart illustrating an example video encoding method according to the techniques of this disclosure. The techniques of FIG. 6 may be carried out by video encoder 20, including, in part, by entropy encoding unit 56.

In one example, video encoder 20 may be configured to execute a method of encoding video data. Video encoder 20 may be configured to synchronize encoding of a first plurality of video block rows at a beginning of each video block row in the first plurality of video block rows (601), encode the first plurality of video block rows in parallel, wherein encoding does not include any synchronization between any subsequent video block in the first plurality of video block rows (602), and synchronize encoding of a second plurality of video block rows at a beginning of each video block row in the second plurality of video block rows (603). In one example, the first plurality of video blocks rows includes two or more CTB rows, and the second plurality of video blocks rows includes two or more CTB rows.

In one example of the disclosure, encoding the plurality of video block rows in parallel comprises determining a value for each syntax element for a particular video block row without using a syntax element from another video block row. In another example of the disclosure determining the value for each syntax element comprises determining a context for encoding a coding unit split flag for a current coding unit in a video block row based on a value of a left coding unit split flag associated with a left coding unit positioned to the left of the current coding unit and based on a depth of the current coding unit, thereby removing the need for a line buffer, and entropy encoding the coding unit split flag using the determined context.

In another example of the disclosure, determining the context for the current coding unit split flag utilizes the following equation: uiCtx=splitFlagLeftCU+((uiDepth>>1)<<1), wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation. This equation produces four possible context values.

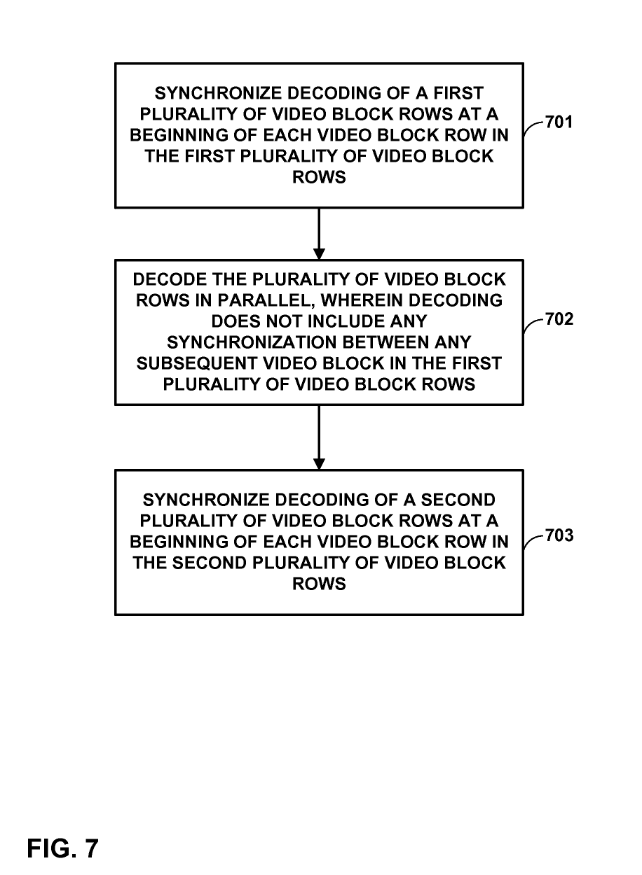

FIG. 7 is a flowchart illustrating an example video decoding method according to the techniques of this disclosure. The techniques of FIG. 7 may be carried out by video decoder 30, including, in part, by entropy decoding unit 80.

In one example, video decoder 30 may be configured to execute a method of decoding video data. Video decoder 30 may be configured to synchronize decoding of a first plurality of video block rows at a beginning of each video block row in the first plurality of video block rows (701), decode the first plurality of video block rows in parallel, wherein decoding does not include any synchronization between any subsequent video block in the first plurality of video block rows (702), and synchronize decoding of a second plurality of video block rows at a beginning of each video block row in the second plurality of video block rows (703). In one example, the first plurality of video blocks rows includes two or more CTB rows, and the second plurality of video blocks rows includes two or more CTB rows.

In one example of the disclosure, decoding the plurality of video block rows in parallel comprises parsing syntax elements in each video block row, and reconstructing each video block row. In another example, parsing syntax element in each video block row comprises determining a value for each syntax element for a particular video block row without using a syntax element from another video block row. In still another example of the disclosure, determining the value for each syntax element comprises determining a context for decoding a coding unit split flag for a current coding unit in a video block row based on a value of a left coding unit split flag associated with a left coding unit positioned to the left of the current coding unit and based on a depth of the current coding unit, thereby removing the need for a line buffer, and entropy decoding the coding unit split flag using the determined context.

In another example of the disclosure, determining the context for the current coding unit split flag utilizes the following equation: uiCtx=splitFlagLeftCU+((uiDepth>>1)<<1), wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation. This equation produces four possible context values.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
synchronizing decoding of a first plurality of video block rows at a beginning of each video block row in the first plurality of video block rows;
decoding the first plurality of video block rows in parallel, wherein decoding does not include any synchronization between any subsequent video block in the first plurality of video block rows; and
synchronizing decoding of a second plurality of video block rows at a beginning of each video block row in the second plurality of video block rows.

2. The method of claim 1, wherein the first plurality of video blocks rows includes two or more coding tree block (CTB) rows, and wherein the second plurality of video blocks rows includes two or more CTB rows.

3. The method of claim 1, wherein decoding the plurality of video block rows in parallel comprises:
parsing syntax elements in each video block row; and
reconstructing each video block row.

4. The method of claim 3, wherein parsing syntax element in each video block row comprises:
determining a value for each syntax element for a particular video block row without using a syntax element from another video block row.

5. The method of claim 4, wherein determining the value for each syntax element comprises:
determining a context for decoding a coding unit split flag for a current coding unit in a video block row based on a value of a left coding unit split flag associated with a left coding unit positioned to the left of the current coding unit and based on a depth of the current coding unit, thereby removing the need for a line buffer; and
entropy decoding the coding unit split flag using the determined context.

6. The method of claim 5, wherein determining the context for the current coding unit split flag utilizes the following equation:
uiCtx=splitFlagLeftCU+((uiDepth>>1)<<1),
wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation.

7. The method of claim 6, wherein the equation produces four possible context values.

8. A method of encoding video data, the method comprising:
synchronizing encoding of a first plurality of video block rows at a beginning of each video block row in the first plurality of video block rows;
encoding the first plurality of video block rows in parallel, wherein encoding does not include any synchronization between any subsequent video block in the first plurality of video block rows; and
synchronizing encoding of a second plurality of video block rows at a beginning of each video block row in the second plurality of video block rows.

9. The method of claim 8, wherein the first plurality of video blocks rows includes two or more coding tree block (CTB) rows, and wherein the second plurality of video blocks rows includes two or more CTB rows.

10. The method of claim 8, wherein encoding the plurality of video block rows in parallel comprises:
determining a value for each syntax element for a particular video block row without using a syntax element from another video block row.

11. The method of claim 10, wherein determining the value for each syntax element comprises:
determining a context for encoding a coding unit split flag for a current coding unit in a video block row based on a value of a left coding unit split flag associated with a left coding unit positioned to the left of the current coding unit and based on a depth of the current coding unit, thereby removing the need for a line buffer; and
entropy encoding the coding unit split flag using the determined context.

12. The method of claim 11, wherein determining the context for the current coding unit split flag utilizes the following equation:
uiCtx=splitFlagLeftCU+((uiDepth>>1)<<1),
wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation.

13. The method of claim 12, wherein the equation produces four possible context values.

14. An apparatus configured to decode video data, the apparatus comprising:
a video decoder configured to:
synchronize decoding of a first plurality of video block rows at a beginning of each video block row in the first plurality of video block rows;
decode the first plurality of video block rows in parallel, wherein decoding does not include any synchronization between any subsequent video block in the first plurality of video block rows; and
synchronize decoding of a second plurality of video block rows at a beginning of each video block row in the second plurality of video block rows.

15. The apparatus of claim 14, wherein the first plurality of video blocks rows includes two or more coding tree block (CTB) rows, and wherein the second plurality of video blocks rows includes two or more CTB rows.

16. The apparatus of claim 14, wherein the video decoder is further configured to:
parse syntax elements in each video block row; and
reconstruct each video block row.

17. The apparatus of claim 16, wherein the video decoder is further configured to:
determine a value for each syntax element for a particular video block row without using a syntax element from another video block row.

18. The apparatus of claim 17, wherein the video decoder is further configured to:
determine a context for decoding a coding unit split flag for a current coding unit in a video block row based on a value of a left coding unit split flag associated with a left coding unit positioned to the left of the current coding unit and based on a depth of the current coding unit, thereby removing the need for a line buffer; and
entropy decode the coding unit split flag using the determined context.

19. The apparatus of claim 18, wherein determining the context for the current coding unit split flag utilizes the following equation:
uiCtx=splitFlagLeftCU+((uiDepth>>1)<<1),
wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation.

20. The apparatus of claim 19, wherein the equation produces four possible context values.

21. An apparatus configured to encode video data, the apparatus comprising:
a video encoder configured to:
synchronize encoding of a first plurality of video block rows at a beginning of each video block row in the first plurality of video block rows;
encode the first plurality of video block rows in parallel, wherein encoding does not include any synchronization between any subsequent video block in the first plurality of video block rows; and
synchronize encoding of a second plurality of video block rows at a beginning of each video block row in the second plurality of video block rows.

22. The apparatus of claim 21, wherein the first plurality of video blocks rows includes two or more coding tree block (CTB) rows, and wherein the second plurality of video blocks rows includes two or more CTB rows.

23. The apparatus of claim 21, wherein the video encoder is further configured to:
determine a value for each syntax element for a particular video block row without using a syntax element from another video block row.

24. The apparatus of claim 23, wherein the video encoder is further configured to:
determine a context for encoding a coding unit split flag for a current coding unit in a video block row based on a value of a left coding unit split flag associated with a left coding unit positioned to the left of the current coding unit and based on a depth of the current coding unit, thereby removing the need for a line buffer; and
entropy encode the coding unit split flag using the determined context.

25. The apparatus of claim 24, wherein determining the context for the current coding unit split flag utilizes the following equation:
uiCtx=splitFlagLeftCU+((uiDepth>>1)<<1),
wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation.

26. The apparatus of claim 25, wherein the equation produces four possible context values.

27. An apparatus configured to decode video data, the apparatus comprising:
means for synchronizing decoding of a first plurality of video block rows at a beginning of each video block row in the first plurality of video block rows;
means for decoding the first plurality of video block rows in parallel, wherein decoding does not include any synchronization between any subsequent video block in the first plurality of video block rows; and
means for synchronizing decoding of a second plurality of video block rows at a beginning of each video block row in the second plurality of video block rows.

28. The apparatus of claim 27, wherein the first plurality of video blocks rows includes two or more coding tree block (CTB) rows, and wherein the second plurality of video blocks rows includes two or more CTB rows.

29. The apparatus of claim 27, wherein the means for decoding the plurality of video block rows in parallel comprises:
means for parsing syntax elements in each video block row; and
means for reconstructing each video block row.

30. The apparatus of claim 29, wherein the means for parsing syntax element in each video block row comprises:
means for determining a value for each syntax element for a particular video block row without using a syntax element from another video block row.

31. The apparatus of claim 30, wherein the means for determining the value for each syntax element comprises:
means for determining a context for decoding a coding unit split flag for a current coding unit in a video block row based on a value of a left coding unit split flag associated with a left coding unit positioned to the left of the current coding unit and based on a depth of the current coding unit, thereby removing the need for a line buffer; and
means for entropy decoding the coding unit split flag using the determined context.

32. The apparatus of claim 31, wherein the means for determining the context for the current coding unit split flag utilizes the following equation:
uiCtx=splitFlagLeftCU+((uiDepth>>1)<<1),
wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation.

33. The apparatus of claim 32, wherein the equation produces four possible context values.

34. An apparatus configured to encode video data, the apparatus comprising:
means for synchronizing encoding of a first plurality of video block rows at a beginning of each video block row in the first plurality of video block rows;
means for encoding the first plurality of video block rows in parallel, wherein encoding does not include any synchronization between any subsequent video block in the first plurality of video block rows; and
means for synchronizing encoding of a second plurality of video block rows at a beginning of each video block row in the second plurality of video block rows.

35. The apparatus of claim 34, wherein the first plurality of video blocks rows includes two or more coding tree block (CTB) rows, and wherein the second plurality of video blocks rows includes two or more CTB rows.

36. The apparatus of claim 34, wherein the means for encoding the plurality of video block rows in parallel comprises:
means for determining a value for each syntax element for a particular video block row without using a syntax element from another video block row.

37. The apparatus of claim 36, wherein the means for determining the value for each syntax element comprises:
means for determining a context for encoding a coding unit split flag for a current coding unit in a video block row based on a value of a left coding unit split flag associated with a left coding unit positioned to the left of the current coding unit and based on a depth of the current coding unit, thereby removing the need for a line buffer; and
means for entropy encoding the coding unit split flag using the determined context.

38. The apparatus of claim 37, wherein the means for determining the context for the current coding unit split flag utilizes the following equation:
uiCtx=splitFlagLeftCU+((uiDepth>>1)<<1),
wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation.

39. The apparatus of claim 38, wherein the equation produces four possible context values.

40. A computer-readable storage medium storing instructions that, when executed, cause one or more processors of a device configured to decode video data to:
synchronize decoding of a first plurality of video block rows at a beginning of each video block row in the first plurality of video block rows;
decode the first plurality of video block rows in parallel, wherein decoding does not include any synchronization between any subsequent video block in the first plurality of video block rows; and
synchronize decoding of a second plurality of video block rows at a beginning of each video block row in the second plurality of video block rows.

41. The computer-readable storage medium of claim 40, wherein the first plurality of video blocks rows includes two or more coding tree block (CTB) rows, and wherein the second plurality of video blocks rows includes two or more CTB rows.

42. The computer-readable storage medium of claim 40, wherein the instructions further cause the one or more processors to:
parse syntax elements in each video block row; and
reconstruct each video block row.

43. The computer-readable storage medium of claim 42, wherein the instructions further cause the one or more processors to:
determine a value for each syntax element for a particular video block row without using a syntax element from another video block row.

44. The computer-readable storage medium of claim 43, wherein the instructions further cause the one or more processors to:
determine a context for decoding a coding unit split flag for a current coding unit in a video block row based on a value of a left coding unit split flag associated with a left coding unit positioned to the left of the current coding unit and based on a depth of the current coding unit, thereby removing the need for a line buffer; and
entropy decode the coding unit split flag using the determined context.

45. The computer-readable storage medium of claim 44, wherein determining the context for the current coding unit split flag utilizes the following equation:
uiCtx=splitFlagLeftCU+((uiDepth>>1)<<1),
wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation.

46. The computer-readable storage medium of claim 45, wherein the equation produces four possible context values.

47. A computer-readable storage medium storing instructions that, when executed, cause one or more processors of a device configured to encode video data to:
synchronize encoding of a first plurality of video block rows at a beginning of each video block row in the first plurality of video block rows;
encode the first plurality of video block rows in parallel, wherein encoding does not include any synchronization between any subsequent video block in the first plurality of video block rows; and
synchronize encoding of a second plurality of video block rows at a beginning of each video block row in the second plurality of video block rows.

48. The computer-readable storage medium of claim 47, wherein the first plurality of video blocks rows includes two or more coding tree block (CTB) rows, and wherein the second plurality of video blocks rows includes two or more CTB rows.

49. The computer-readable storage medium of claim 47, wherein the instructions further cause the one or more processors to:
determine a value for each syntax element for a particular video block row without using a syntax element from another video block row.

50. The computer-readable storage medium of claim 49, wherein the instructions further cause the one or more processors to:
determine a context for encoding a coding unit split flag for a current coding unit in a video block row based on a value of a left coding unit split flag associated with a left coding unit positioned to the left of the current coding unit and based on a depth of the current coding unit, thereby removing the need for a line buffer; and
entropy encode the coding unit split flag using the determined context.

51. The computer-readable storage medium of claim 50, wherein determining the context for the current coding unit split flag utilizes the following equation:
uiCtx=splitFlagLeftCU+((uiDepth>>1)<<1),
wherein uiCtx is the determined context, splitFlagLeftCU is the value of the left coding unit split flag, uiDepth is the depth of the current coding unit, the symbol >> denotes a bit-wise right shift operation, and the symbol << denotes a bit-wise left shift operation.

52. The computer-readable storage medium of claim 51, wherein the equation produces four possible context values.
